(19) United States
(12) Patent Application Publication
(10) Pub. No.: US 2023/0169324 A1
(43) Pub. Date: Jun. 1, 2023

(54) USE SYNTHETIC DATASET TO TRAIN ROBOTIC DEPALLETIZING

(71) Applicant: FANUC CORPORATION, YAMANASHI (JP)

(72) Inventors: Te Tang, Fremont, CA (US); Tetsuaki Kato, Fremont, CA (US)

(21) Appl. No.: 17/538,270

(22) Filed: Nov. 30, 2021

(51) Int. Cl. G06N 3/08; G06V 10/82; G06V 10/24; G06V 20/70; G06V 20/64

(52) U.S. Cl. CPC G06N 3/08; G06V 10/82; G06V 10/24; G06V 20/70; G06V 20/64

(57) ABSTRACT

A system and method for training a neural network. The method includes modelling a plurality of different sized objects to generate virtual images of the objects using computer graphics software and generating a placement virtual image by randomly and sequentially selecting the modelled objects and placing the selected modelled objects within a predetermined boundary in a predetermined pattern using the software. The method also includes rendering a virtual image of the placement virtual image based on predetermined data and information using the computer graphics software and generating an annotated virtual image by independently labeling the objects in the rendered virtual image using the software. The method repeats generating a placement virtual image, rendering a virtual image and generating an annotated virtual for a plurality of randomly and sequentially selected modelled objects, and then trains the neural network using the plurality of rendered virtual images and the annotated virtual images.

### BACKGROUND

### Field

This disclosure relates generally to a system and method for training a neural network and, more particularly, to a system and method for training a neural network that could be used in a robot controller for identifying a box to be picked up by the robot from a stack of boxes, where the method employs using computer graphics software to generate virtual images of the boxes and automatically labelling the boxes based on their orientation in the virtual images.

### Discussion of the Related Art

Robots perform a multitude of commercial tasks including pick and place operations, where the robot picks up and moves objects from one location to another location. For example, the robot may pick up boxes off of a pallet and place the boxes on a conveyor belt, where the robot likely employs an end-effector with suction cups to hold the boxes. In order for the robot to effectively pick up a box, the robot needs to know the width, length and height of the box it is picking up, which is input into the robot controller prior to the pick and place operation. However, often times the boxes on the same pallet have different sizes, which makes it inefficient to input the size of the boxes into the robot during the pick and place operation. The boxes can also be placed side-by-side at the same height, where it is challenging to distinguish whether they are separate boxes or a single large box.

Deep learning is a particular type of machine learning that provides greater learning performance by representing a certain real-world environment as a hierarchy of increasing complex concepts. Deep learning typically employs a software structure including several layers of neural networks that perform nonlinear processing, where each successive layer receives an output from the previous layer. Generally, the layers include an input layer that receives raw data from a sensor, a number of hidden layers that extract abstract features from the data, and an output layer that identifies a certain thing based on the feature extraction from the hidden layers. The neural networks include neurons or nodes that each has a “weight” that is multiplied by the input to the node to obtain a probability of whether something is correct. More specifically, each of the nodes has a weight that is a floating point number that is multiplied with the input to the node to generate an output for that node that is some proportion of the input. The weights are initially “trained” or set by causing the neural networks to analyze a set of known data under supervised processing and through minimizing a cost function to allow the network to obtain the highest probability of a correct output. Deep learning neural networks are often employed to provide image feature extraction and transformation for the visual detection and classification of objects in an image, where a video or stream of images can be analyzed by the network to identify and classify objects and learn through the process to better recognize the objects. Thus, in these types of networks, the system can use the same processing configuration to detect certain objects and classify them differently based on how the algorithm has learned to recognize the objects.

The number of layers and the number of nodes in the layers in a neural network determine the network's complexity, computation time and performance accuracy. The complexity of a neural network can be reduced by reducing the number of layers in the network, the number of nodes in the layers or both. However, reducing the complexity of the neural network reduces its accuracy for learning, where it has been shown that reducing the number of nodes in the layers has accuracy benefits over reducing the number of layers in the network.

U.S. patent application Ser. No. 17/015,817, filed Sep. 9, 2020, titled, Mix-Size Depalletizing, assigned to the assignee of this application and herein incorporated by reference, discloses a system and method for identifying a box to be picked up by a robot from a stack of boxes. The method includes obtaining a 2D red-green-blue (RGB) color image of the boxes and a 2D depth map image of the boxes using a 3D camera, where pixels in the depth map image are assigned a value identifying the distance from the camera to the boxes. The method employs a modified deep learning mask R-CNN (convolutional neural network) that generates a segmentation image of the boxes by performing an image segmentation process that extracts features from the RGB image and the depth map image, combines the extracted features in the images and assigns a label to the pixels in a features image so that each box in the segmentation image has the same label. The method then identifies a location for picking up the box using the segmentation image.

The method described in the '817 application has been shown to be effective for identifying a box in a stack of boxes for a robot to pick up. However, the method disclosed in the '817 application employs a deep learning neural network for an image filtering step, a region proposal step and a binary segmentation step. These types of deep learning neural networks require significant processing so that in order to have realistic and practical robot pick-up times, a graphics processing unit (GPU), which provides greater speeds over central processing units (CPU) generally because of parallel processing, is typically necessary to be used for the deep learning neural network computations. For example, by employing a CPU for the neural network processing in the '817 method, the process will take about 2.272 seconds to identify a box to be picked up, whereas using a GPU for the neural network processing in the '817 method, the process only requires about 0.1185 seconds. However, industrial applications, such as robotic systems, are currently not conducive for employing GPUs because of the standard protocols currently being used and the harsh environment that these systems are often subjected to.

U.S. patent application Ser. No. 17/456,977, filed Nov. 30, 2021, titled, Algorithm for Mix-Size Depalletizing, assigned to the assignee of this application and herein incorporated by reference, discloses system and method for identifying a box to be picked up by a robot from a stack of boxes that employs a CPU. The method includes obtaining a 2D RGB color image of the boxes and a 2D depth map image of the boxes using a 3D camera. The method employs an image segmentation process that uses a simplified mask R-CNN executable by a CPU to predict which pixels in the RGB image are associated with each box, where the pixels associated with each box are assigned a unique label that combine to define a mask for the box. The method then identifies a location for picking up the box using the segmentation image. In one non-limiting embodiment, the size of the neural network is accomplished by decreasing the number of nodes in the layers by half. However, by reducing the number of nodes in the neural network, the ability of the neural network to accurately predict the location and orientation of the box is significantly reduced, where the edges of the box are difficult to predict. For example, the segmentation process would require the use of larger bounding boxes to ensure that the entire box was identified in the image. Therefore additional processing steps are performed to more accurately identify the location of the box being picked up by the robot.

Both the '817 and '977 applications employ deep learning neural networks that require generating neural network models for the types of boxes being identified for each de-palletizing application. Generating the neural network models require significant training data to train the neural network for each robotic pick and place application. Further, it is necessary to label or provide an annotation for each box in the images by drawing bounding boxes around each box in the image, where hundreds of images may be required with thousands of labels. However, collecting such training data for the neural network and performing the labeling process are very time consuming and expensive.

### SUMMARY

The following discussion discloses and describes a system and method training a neural network that could be used for identifying a box to be picked up by a robot from a stack of boxes, where the method employs using computer graphics software to generate virtual images of the boxes and automatically labelling the boxes based on their orientation in the virtual images. The method includes modelling a plurality of different sized objects to generate virtual images of the objects using computer graphics software and generating a placement virtual image by randomly and sequentially selecting the modelled objects and placing the selected modelled objects within a predetermined boundary in a predetermined pattern using the computer graphics software. The method also includes rendering a virtual image of the placement virtual image based on predetermined data and information using the computer graphics software and generating an annotated virtual image by independently labeling the objects in the rendered virtual image using the computer graphics software. The method repeats generating a placement virtual image, rendering a virtual image and generating an annotated virtual for a plurality of randomly and sequentially selected modelled objects, and then trains the neural network using the plurality of rendered virtual images and the annotated virtual images.

Additional features of the disclosure will become apparent from the following description and appended claims, taken in conjunction with the accompanying drawings.

### BRIEF DESCRIPTION OF THE DRAWINGS

FIG. 1 is an illustration of a robot system including a robot picking up boxes off of a pallet and placing them on a conveyor belt;

FIG. 2 is a block diagram of an image segmentation module used in the system shown in FIG. 1;

FIG. 3 is a flow chart diagram showing a process for generating virtual RGB images and virtual mask images for training a neural network;

FIG. 4 illustrates a virtual image of a box that has not had texture applied thereto;

FIG. 5 is the virtual image of the box shown in FIG. 4 that has had texture applied thereto;

FIG. 6 is an illustration of a developing positional image including a boundary representing a pallet and boxes within the boundary;

FIG. 7 is a top view of a rendered virtual RGB image;

FIG. 8 is a block diagram of a system for rendering the virtual RGB image; and

FIG. 9 is a top view of a virtual annotated image.

### DETAILED DESCRIPTION OF THE EMBODIMENTS

The following discussion of the embodiments of the disclosure directed to a system and method for training a neural network that could be used for identifying a box to be picked up by a robot from a stack of boxes, where the method employs using computer graphics software to generate virtual images of the boxes and automatically labelling the boxes based on their orientation in the virtual images, is merely exemplary in nature, and is in no way intended to limit the invention or its applications or uses. For example, the system and method have application for training a neural network that is employed to identify a box to be picked up by a robot. However, the system and method may have other applications.

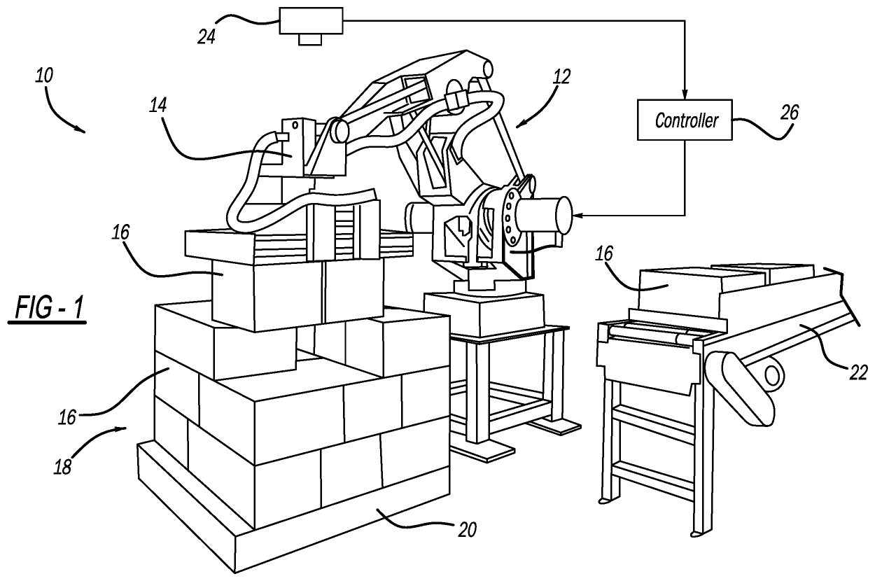

FIG. 1 is an illustration of a robot system 10 including a robot 12 having an end-effector 14 that is configured for picking up boxes 16 from a stack 18 of the boxes 16 positioned on a pallet 20 and placing them on a conveyor belt 22. The system 10 is intended to represent any type of robot system that can benefit from the discussion herein, where the robot 12 can be any robot suitable for that purpose. A 3D camera 24 is positioned to take top down 2D RBG and depth map images of the stack 18 of the boxes 16 and provide them to a robot controller 26 that controls the movement of the robot 12. The boxes 16 may have different orientations on the pallet 20, may be stacked in multiple layers on the pallet 20 and may have different sizes. As will be discussed in detail below, the robot controller 26 employs an algorithm that determines the size of each of the boxes 16 the robot 12 will be picking up without the length, width and height of the box 16 being previously input into the controller 26 and without the need to generate projection templates of the boxes 16.

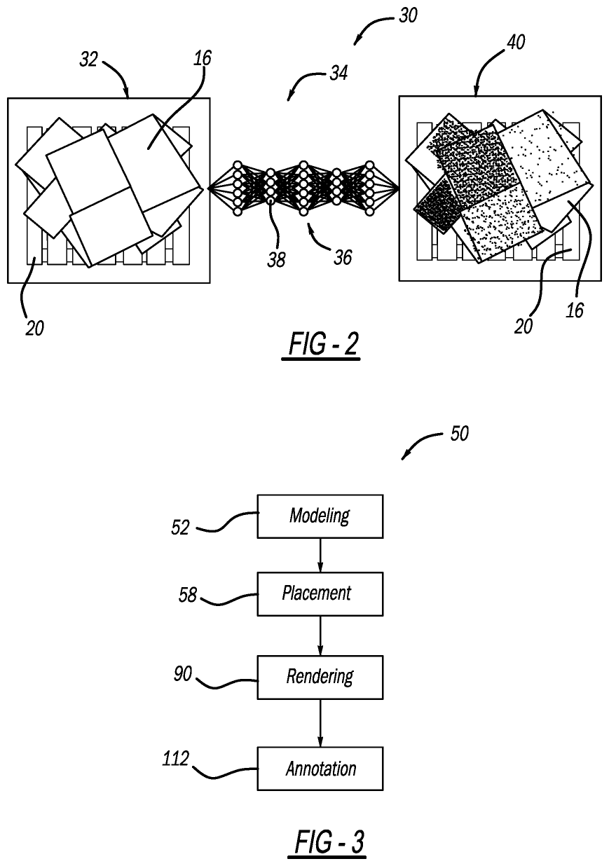

FIG. 2 is a block diagram of an image segmentation module 30 that is part of the controller 26 in the robot system 10 that performs an image segmentation process that assigns a label to every pixel in an image from the camera 24 such that the pixels with the same label share certain characteristics. Thus, the segmentation process predicts which pixel belongs to which of the boxes 16, where different indicia represent different boxes 16. The module 30 receives a 2D RGB image 32 of a top view of the boxes 16 positioned on the pallet 20 from the camera 24. The image 32 is sent to a deep learning image segmentation neural network 34 having layers 36 with nodes 38 that performs the image segmentation process, and generates a segmentation image 40, where the image 40 shows the boxes 16 being annotated or labeled by certain indicia, such as colors to distinguish the boxes 16. The image segmentation neural network 34 can be any neural network suitable for the discussion herein, such as those disclosed in the '817 and '977 applications.

As will be discussed in detail below, this disclosure proposes a system and method for training the neural network 34 to identifying the size and position of the boxes 16 to be picked up without requiring the traditional expensive and time consuming dataset preparation process for training deep learning neural networks known the in the art. The method uses computer graphics software to generate virtual images of many configurations of the boxes 16. Since the pose of the boxes 16 in the virtual images is known, a boundary mask identifying the shape of the boxes 16 can be labelled automatically by the software.

FIG. 3 is a flow chart diagram 50 showing a process for generating virtual images that will be used to train the neural network 34 in this manner. At box 52, every size and shape box that could be one that the robot 12 would pick up is modelled. The modeling process includes generating a virtual image of a six-sided blank box using computer graphics software, for example, Blender™, where each side of the box has a certain length and width, and then adding texture to each side of the box so that it has the appearance of a real box. The blank box is illustrated by a mesh configuration that identifies the box by x, y and z coordinates. In one non-limiting embodiment, adding the texture includes taking a digital picture of each side of a real box, uploading the pictures to the computer to be available to the computer graphics software and then selecting and dragging one of the pictures onto each side of the box. The picture is dragged to the box on the computer screen and the corners of the picture are modified to match the corners on the side of the box.

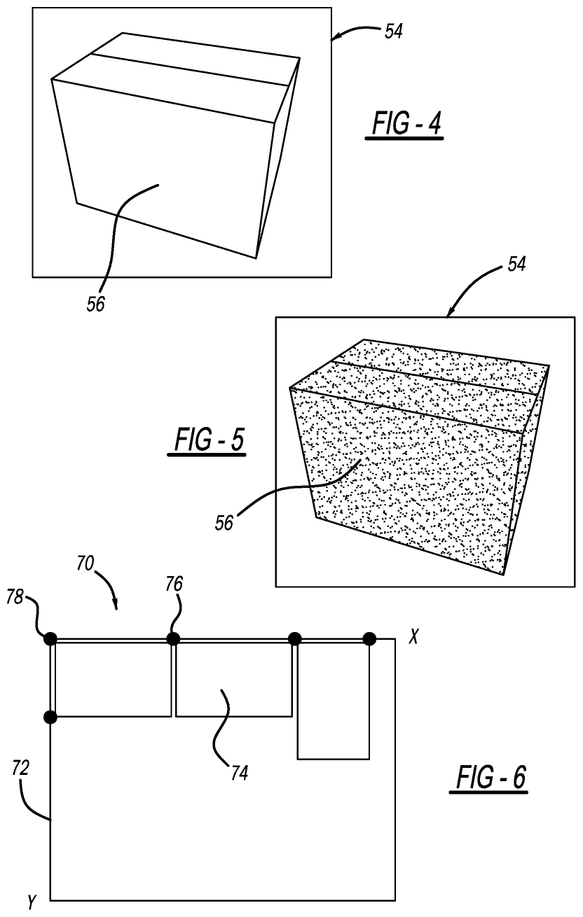

FIG. 4 illustrates a plain virtual image 54 of a virtual box 56 generated by the software that has not had texture applied thereto and FIG. 5 is the virtual image 54 of the box 56 that has had texture applied thereto by the software. This process is repeated for each size box that could be picked up by the robot 12.

Once the database of virtual boxes with texture are generated, then the computer graphics software is used to generate placement data and information for many configurations of those boxes within a rectangular boundary representing the pallet 20 at box 58, where the location of each corner of the boundary is known and one of the corners of the boundary is selected as a default pivot point with an x, y and z coordinate value of (0, 0, 0). One of the virtual boxes 56 is selected and a corner of that box is positioned at the default pivot point in the boundary, where the software will know the x, y, z coordinate location of the other corners of the box 56 in the boundary. The software then updates the pivot point to the location of the corner of the placed box 56 along a certain direction, such as the x-direction, and then randomly selects another box 56 to be placed in the boundary so that a corner of that next box is positioned at the new pivot point. Each time a box is placed, constraints are checked including whether the placed box is entirely within the boundary and whether the placed box intersects or overlaps another already placed box, and if either of these constraints is not met, the box is rotated or possibly removed. Another constraint includes making sure the boxes are closely packed together. If none of the virtual boxes can be placed in the x-direction without remaining inside the boundary, then the software moves to a pivot point at the other side of the boundary defined by a corner of the first placed box. The box placement process is continued in all of the x, y and z directions until one of the constraints cannot be satisfied for every virtual box that can be selected, where the height, z-direction, limitation is predetermined.

FIG. 6 is an illustration of the placement process showing a placement image 70 including a boundary 72 representing the pallet 20 and boxes 74, representing the boxes 56, placed by the software within the boundary 72 along the x-direction. Dots 76 represent the pivot points, where dot 78 is the default pivot point. Once the placement of the boxes 56 is complete, then the software stores the pose or orientation of each of the boxes 56 for this configuration of the boxes 56 based on their x, y and z coordinate position.

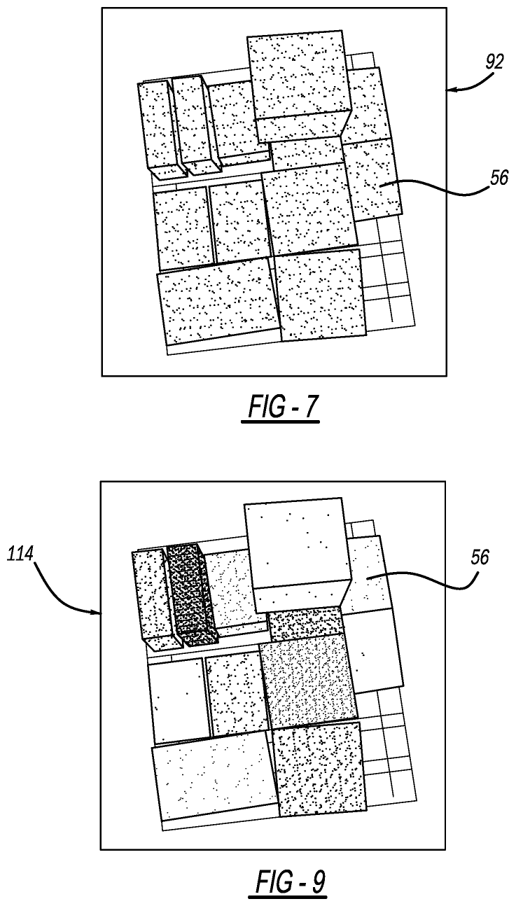

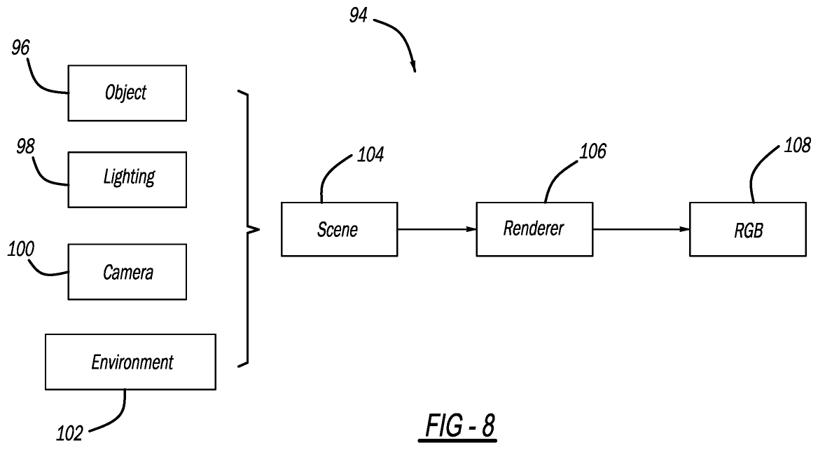

Once a complete positional representation of the boxes 56 is provided, a virtual RGB image 92 of the configuration of the boxes 56 is rendered at box 90, as shown in FIG. 7, using, for example, the Blender™ computer graphics software referred to above. FIG. 8 is a block diagram of a system 94 for generating the rendered virtual RGB image 92. The system 94 receives a number of inputs including virtual simulation information about the boxes 16 at object module 96, virtual simulation information about the lighting around the robot 12 at lighting module 98, virtual simulation information about the camera 24 at camera module 100 and virtual simulation information about the simulated environment around the robot 12 at environment module 102. Particularly, the object module 96 provides data concerning the mesh of the boxes 56, the pose of the boxes 36 from the placement process at the box 58 and the material of the boxes 56. This information is already available from the computer graphics software that generated the virtual image 54 shown in FIG. 5. The lighting module 98 sets simulation data concerning the pose or orientation of the boxes 56, the color of the light in a simulated environment around the robot 12 and the intensity of the light in the simulated environment around the robot 12. The camera module 100 sets simulation data concerning the pose of a virtual camera representing the camera 24, the field-of-view (FOV) of the virtual camera, the resolution of the virtual camera and the focus of the virtual camera. The environment module 102 sets simulation data concerning the background around the robot 12 and light reflection around the robot 12. The various settings provided by the lighting module 98, the camera module 100 and the environment module 102 are selected and possibly adjusted and modified for the particular robot system 10 for the particular use and application.

The background data includes a representation of the ground and the pallet 20 in the virtual environment around the robot 12. This data and information is used by a scene module 104 to generate a virtual background image. The virtual boxes are placed on the virtual background image using the placement information from the object module 96 in the module 104. The scene information is used by a render engine in a render module 106 along with information obtained from the lighting module 98 and the camera module 100 to generate the RGB image 92 at box 108, where the render engine can be a suitable computer graphics software, such as Blender™.

The process then annotates each of the boxes 56 in the virtual RGB image 92 at box 112 so that each box 56 in the image 92 has a unique label or mask. The annotation process can be performed using the system 94 to obtain a virtual mask image, where the texture of the box 56 that is provided as an input to the object module 96 is replaced with a unique representation for each box 56, such as a unique color in the virtual RGB image 92. FIG. 9 is a top view of a virtual mask image 114 showing the annotated virtual RGB image.

Once the virtual RGB image 92 and the virtual mask image 114 are obtained for one representation of the boxes 56, then the process of determining the configuration of the boxes at the box 58 and rendering a virtual RGB image at the box 90 is repeated many times for different configurations of the boxes 56 to provide many different virtual RGB and mask images, for example, 5000 different virtual RGB and mask images. The virtual RGB images and the virtual mask images are then used to train the neural network 34, and once the neural network 34 is trained it is tested using images of real boxes. The controller 26 is then ready to pick and place the boxes 16 in a real world operation.

As will be well understood by those skilled in the art, the several and various steps and processes discussed herein to describe the disclosure may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for training a neural network, said method comprising:
modelling a plurality of different sized objects to generate virtual images of the objects using computer graphics software;
generating a placement virtual image by randomly and sequentially selecting the modelled objects and placing the selected modelled objects within a predetermined boundary in a predetermined pattern using the computer graphics software;
rendering a virtual image of the placement virtual image based on predetermined data and information using the computer graphics software;
generating an annotated virtual image by independently labeling the objects in the rendered virtual image using the computer graphics software;
repeating generating a placement virtual image, rendering a virtual image and generating an annotated virtual for a plurality of randomly and sequentially selected modelled objects; and
training the neural network using the plurality of rendered virtual images and the annotated virtual images.

2. The method according to claim 1 wherein modelling the plurality of different sized objects includes taking pictures of all sides of the objects and uploading the pictures to the computer graphics software.

3. The method according to claim 2 wherein modelling the plurality of different sized objects includes generating a non-textured virtual image of the objects, selecting the pictures and aligning the pictures with sides of the objects to generate textured virtual images of the objects.

4. The method according to claim 1 wherein generating a placement virtual image includes selecting a default pivot point in the boundary, placing a selected modelled object at the pivot point, identifying an updated pivot point based on the position of the placed modelled object, placing another modelled object at the updated pivot point, and repeating updating the pivot point and placing modelled objects in a certain sequence in an x, y and z-direction until the placement virtual image is generated.

5. The method according to claim 4 wherein the placement of modelled objects is subject to predetermining constraints including whether the placed modelled object is completely within the boundary and whether the placed modelled object intersects another already placed modelled object.

6. The method according to claim 1 wherein the predetermined data and information used for rendering a virtual image of the placement virtual image includes pose and material of the objects, color and strength of lighting in a simulated environment around the neural network, field-of-view, resolution and focus of a virtual camera and background and reflection in the environment.

7. The method according to claim 1 wherein generating the annotated virtual image includes using pose and indicia of the objects, color and strength of lighting in a simulated environment around the neural network, field-of-view, resolution and focus of a virtual camera and background and reflection in the environment.

8. The method according to claim 1 wherein the objects are cardboard boxes.

9. The method according to claim 1 wherein the neural network is used to control a robot picking up the objects.

10. A method for training a neural network that is employed in a robot controller that picks up boxes, said method comprising:
modelling a plurality of different sized boxes to generate virtual images of the boxes using computer graphics software;
generating a placement virtual image by randomly and sequentially selecting the modelled boxes and placing the selected modelled boxes within a predetermined boundary in a predetermined pattern using the computer graphics software, wherein generating a placement virtual image includes selecting a default pivot point in the boundary, placing a selected modelled box at the pivot point, identifying an updated pivot point based on the position of the placed modelled box, placing another modelled box at the updated pivot point, and repeating updating the pivot point and placing modelled boxes in a certain sequence in an x, y and z-direction until the placement virtual image is generated;
rendering a virtual image of the placement virtual image based on predetermined data and information using the computer graphics software, wherein the predetermined data and information used for rendering a virtual image of the placement virtual image includes pose and material of the boxes, color and strength of lighting in a simulated environment around the neural network, field-of-view, resolution and focus of a virtual camera and background and reflection in the environment;
generating an annotated virtual image by independently labeling the boxes in the rendered virtual image using the computer graphics software, wherein generating the annotated virtual image includes using pose and indicia of the boxes, color and strength of lighting in the environment around the neural network, field-of-view, resolution and focus of the virtual camera and background and reflection in the environment;
repeating generating a placement virtual image, rendering a virtual image and generating an annotated virtual for a plurality of randomly and sequentially selected modelled boxes; and
training the neural network using the plurality of rendered virtual images and the annotated virtual images.

11. The method according to claim 10 wherein modelling the plurality of different sized boxes includes taking pictures of all sides of the boxes and uploading the pictures to the computer graphics software.

12. The method according to claim 11 wherein modelling the plurality of different sized boxes includes generating a non-textured virtual image of the boxes, selecting the pictures and aligning the pictures with sides of the boxes to generate textured virtual images of the boxes.

13. The method according to claim 10 wherein the placement of modelled boxes is subject to predetermining constraints including whether the placed modelled box is completely within the boundary and whether the placed modelled box intersects another already placed modelled box.

14. A system for training a neural network, said system comprising:
means for modelling a plurality of different sized objects to generate virtual images of the objects using computer graphics software;
means for generating a placement virtual image by randomly and sequentially selecting the modelled objects and placing the selected modelled objects within a predetermined boundary in a predetermined pattern using the computer graphics software;
means for rendering a virtual image of the placement virtual image based on predetermined data and information using the computer graphics software;
means for generating an annotated virtual image by independently labeling the objects in the rendered virtual image using the computer graphics software;
means for repeating generating a placement virtual image, rendering a virtual image and generating an annotated virtual for a plurality of randomly and sequentially selected modelled objects; and
means for training the neural network using the plurality of rendered virtual images and the annotated virtual images.

15. The system according to claim 14 wherein the means for modelling the plurality of different sized objects takes pictures of all sides of the objects and uploads the pictures to the computer graphics software.

16. The system according to claim 15 wherein the means for modelling the plurality of different sized objects generates a non-textured virtual image of the objects, selects the pictures and aligns the pictures with sides of the objects to generate textured virtual images of the objects.

17. The system according to claim 14 wherein the means for generating a placement virtual image selects a default pivot point in the boundary, places a selected modelled object at the pivot point, identifies an updated pivot point based on the position of the placed modelled object, places another modelled object at the updated pivot point, and repeats updating the pivot point and placing modelled objects in a certain sequence in an x, y and z-direction until the placement virtual image is generated.

18. The system according to claim 17 wherein the placement of modelled objects is subject to predetermining constraints including whether the placed modelled object is completely within the boundary and whether the placed modelled object intersects another already placed modelled object.

19. The system according to claim 14 wherein the predetermined data and information used for rendering a virtual image of the placement virtual image includes pose and material of the objects, color and strength of lighting in a simulated environment around the neural network, field-of-view, resolution and focus of a virtual camera and background and reflection in the environment.

20. The system according to claim 14 wherein the means for generating the annotated virtual image uses pose and indicia of the objects, color and strength of lighting in a simulated environment around the neural network, field-of-view, resolution and focus of a virtual camera and background and reflection in the environment.
